(19) United States
(12) Patent Application Publication
(10) Pub. No.: US 2024/0348870 A1
(43) Pub. Date: Oct. 17, 2024

(54) VIDEO PROCESSING APPARATUS, VIDEO PROCESSING METHOD AND PROGRAM

(71) Applicant: NIPPON TELEGRAPH AND TELEPHONE CORPORATION, Tokyo (JP)

(72) Inventors: Hidenobu NAGATA, Musashino-shi, Tokyo (JP); Hirokazu KAKINUMA, Musashino-shi, Tokyo (JP); Shota YAMADA, Musashino-shi, Tokyo (JP)

(73) Assignee: NIPPON TELEGRAPH AND TELEPHONE CORPORATION, Tokyo (JP)

(21) Appl. No.: 18/294,169

(22) PCT Filed: Aug. 5, 2021
(86) PCT No.: PCT/JP2021/029145

§ 371 Date: Feb. 1, 2024

(51) Int. Cl. H04N 21/4402; G06T 11/00; H04N 21/43; H04N 21/442

(52) U.S. Cl. CPC H04N 21/44029; G06T 11/001; H04N 21/43072; H04N 21/44218

(57) ABSTRACT

A video processing apparatus that generates an event video with a higher entertainment level by utilizing style conversion is provided. A video processing apparatus according to an embodiment includes a video acquisition unit, a reaction acquisition unit, a generation unit, a conversion unit, and an output unit. The video acquisition unit acquires a first video related to an event. The reaction acquisition unit acquires information indicating a reaction of a viewer watching the event. The generation unit generates dynamic style data on the basis of the information indicating the reaction of the viewer. The conversion unit executes style conversion on the first video using the dynamic style data to generate a second video subjected to style conversion. The output unit outputs the second video.

### TECHNICAL FIELD

Embodiments of the present invention relate to a video processing apparatus, a video processing method, and a program.

### BACKGROUND ART

Style conversion for reflecting a style, texture, or the like of past works of art in an image or a video is known. The style conversion is an image processing technique for changing the style while holding the content (shape, or the like) of an image. Such style conversion makes it possible to convert a material image into an image of a desired style, and is becoming common in creating scenes of a movie or the like. To create a video after style conversion, a method for processing frame images of a recorded material video using image retouching software, CG software, or the like, or converting the frame images using a program can be adopted (for example, see NPL 1 and NPL 2).

### CITATION LIST

### Non Patent Literature

[NPL 1] Gatys, L. A., Ecker, A. S., Bethge, M., “Image Style Transfer Using Convolutional Neural Networks”, Proceedings of the IEEE Conference on Computer Vision and Pattern Recognition, pp. 2414-2423 (2016)
[NPL 2] Justin Johnson, Alexandre Alahi, Li Fei-Fei, “Perceptual Losses for Real-Time Style Transfer and Super-Resolution”, CVPR 2016, 27 Mar. 2016

### SUMMARY OF INVENTION

### Technical Problem

Style conversion is still limited in its field of application. It is expected that style conversion will be utilized in the entertainment field, including the performing arts.

An object of the present invention is to provide a video processing apparatus, a video processing method, and a program that utilize style conversion to generate an event video at a higher entertainment level.

### Solution to Problem

A video processing apparatus according to an embodiment includes a video acquisition unit, a reaction acquisition unit, a generation unit, a conversion unit, and an output unit. The video acquisition unit acquires a first video related to an event. The reaction acquisition unit acquires information indicating a reaction of a viewer watching the event. The generation unit generates dynamic style data on the basis of the information indicating the reaction of the viewer. The conversion unit executes style conversion on the first video using the dynamic style data to generate a second video subjected to style conversion. The output unit outputs the second video.

### Advantageous Effects of Invention

According to the embodiment, style conversion using dynamic style data generated on the basis of the information indicating the reaction of the viewer is executed on the first video related to an event. The second video obtained by this style conversion is an event video at a higher entertainment level, which reflects a real-time reaction of the viewer.

Therefore, according to the embodiments, the video processing apparatus, the video processing method, and the program that utilize style conversion to generate an event video at a higher entertainment level are provided.

### BRIEF DESCRIPTION OF DRAWINGS

FIG. 1 is a diagram illustrating a functional configuration example of a video processing apparatus according to an embodiment of the present invention.

FIG. 2 is a block diagram illustrating a hardware configuration example of the video processing apparatus illustrated in FIG. 1.

FIG. 3 is a flowchart illustrating an operation example of the video processing apparatus illustrated in FIG. 1.

FIG. 4 is a diagram illustrating a modification example of the functional configuration of the video processing apparatus illustrated in FIG. 1.

### DESCRIPTION OF EMBODIMENTS

Hereinafter, embodiments of the present invention will be described with reference to the drawings. Elements that are the same as or similar to elements that have already been described are denoted by the same or similar reference signs, and repeated description will be basically omitted. For example, when there are a plurality of same or similar elements, common reference signs may be used to describe the respective element without distinction, and branch signs may be used in addition to the common reference signs to distinguish and describe the respective elements.

### Embodiment

### (Configuration)

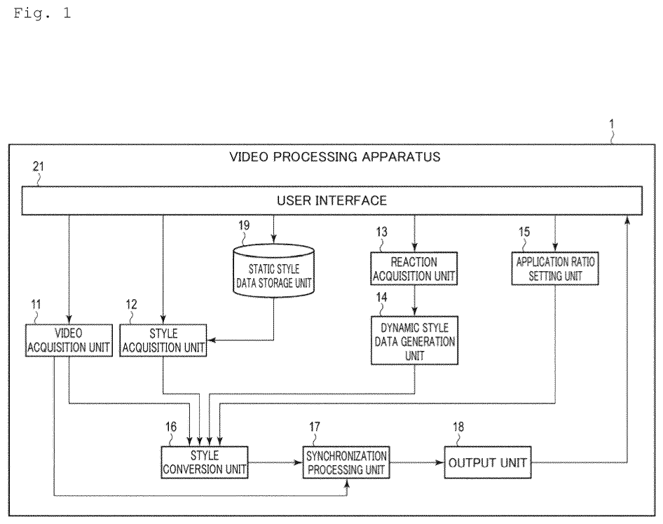

FIG. 1 is a diagram illustrating a functional configuration example of a video processing apparatus 1 according to an embodiment of the present invention.

The video processing apparatus 1 utilizes style conversion in the field of stage entertainment, including performing arts.

In FIG. 1, the video processing apparatus 1 includes a video acquisition unit 11, a style acquisition unit 12, a reaction acquisition unit 13, a dynamic style data generation unit 14, an application ratio setting unit 15, a style conversion unit 16, a synchronization processing unit 17, an output unit 18, a static style data storage unit 19, and a user interface 21.

The user interface 21 is a user interface for style conversion control. The user interface 21 enables information exchange between the video processing apparatus 1 and the user. Here, the user is an operator of the video processing apparatus 1, for example.

The static style data storage unit 19 stores static style data. The static style data is stored in advance by the user of the video processing apparatus 1, for example. Static style data includes various texture images. As examples of the texture image, photographs of inorganic materials such as water, fire, cloth, paper, wood, stone, and sand, or an image indicating features thereof, textures used in design represented by diagonal lines or dots or the like, or a texture image that characteristically expresses a style of a painting such as a part of a famous painting is used as the static style data. Further, in addition to these images, feature quantities of images associated with words expressing texture such as rough, smooth, and glitter, and feature quantities that can express, for example, gloss generated by a neural network can also be applied as the static style data.

The video acquisition unit 11 acquires a video that is a target of the style conversion. The video acquisition unit 11 is an example of a video acquisition unit that acquires a first video related to an event. The video acquisition unit 11 acquires the first video related to the event, for example, as a video from a camera (not illustrated). The event includes various events related to the entertainment field in which the presence of viewers is assumed. The event is not limited to stages, such as performing arts (for example, a theater, music, or dance), entertainment, and sports, and can include events that are realized in a predetermined space. The event may be an event realized in a real space, an event realized in a virtual space, or a combination thereof. The event may be rephrased as content. The video acquired by the video acquisition unit 11 is, for example, a video obtained by filming a state of a live music performance on stage or a video obtained by filming an actor in the performing arts. These include still images or moving images.

The style acquisition unit 12 acquires the static style data from the static style data storage unit 19. For example, the style acquisition unit 12 receives designation of a texture to be applied to the style conversion from the user via the user interface 21, and reads the static style data corresponding to the designated texture from the static style data storage unit 19. In the style acquisition, the style acquisition unit 12 can acquire some or all of the pieces of data stored in the static style data storage unit 19 as a style in any combination.

The reaction acquisition unit 13 acquires information indicating a reaction of a viewer who watches an event. Specifically, the reaction acquisition unit 13 acquires, for example, a motion of a hand of the viewer, light of chemical light (pen light) waved by the viewer, an appearance of a single viewer, an appearance of viewers in a collected state at audience seats or the like, the brightness of the audience seats, a magnitude of noise, or a screen at a distribution site when the video is streamed at the time of an event or stage performance, as the reaction of viewers who are watching the event. The user interface 21 can be used to designate which of the reactions according to the example is to be adopted by the system. The reaction acquisition unit 13 is an example of a reaction acquisition unit that acquires information indicating a reaction of a viewer who watches an event.

The dynamic style data generation unit 14 processes the information acquired by the reaction acquisition unit 13, and generates dynamic style data as an element of the style conversion. Specifically, the dynamic style data generation unit 14 generates, for example, an amount for each frame of a motion of the hand of the viewer acquired by the reaction acquisition unit 13, a luminance value for each frame of light color of the chemical light waved by the viewer acquired by the reaction acquisition unit 13, a luminance value for each frame of a specific color among the light colors of the chemical light waved by the viewer acquired by the reaction acquisition unit 13, a value for each frame of a motion vector extracted from a moving image obtained by filming a single viewer acquired by the reaction acquisition unit 13, a value for each frame of a total amount of a motion vector that can be extracted from a moving image obtained by filming viewers in a collected state at audience seats or the like, which has been acquired by the reaction acquisition unit 13, brightness of the audience seat for each frame that can be extracted from the moving image obtained by filming the viewers in a collected state at audience seats or the like, which has been acquired by the reaction acquisition unit 13, the number of regions having a luminance value equal to or greater than a certain value, that is, the number of “bright points” for each frame that can be extracted from the moving image obtained by filming the viewers in a collected state at audience seats or the like, which has been acquired by the reaction acquisition unit 13, a sound pressure for each frame obtained from the sound in the audience seats acquired by the reaction acquisition unit 13, and characters written on a streaming distribution site or bulletin board site, or a total amount of characters acquired by the reaction acquisition unit 13, a color of characters, a speed at which characters are scrolled, or a font size of the characters, as the dynamic style data. The dynamic style data generation unit 14 is an example of a generation unit that generates dynamic style data on the basis of the information indicating the reaction of the viewer.

The application ratio setting unit 15 sets an application ratio between the static style data and the dynamic style data. For example, the application ratio setting unit 15 receives the designation of the application ratio from the user via the user interface 21, and sets the application ratio for the style conversion unit 16, which will be described below. The user can designate the application ratio via a graphical user interface (GUI) component displayed on, for example, a display. An example of the GUI component is a slider that can select the ratio of the static style data and the dynamic style data through a drag operation or the like. The user may be able to input a numerical value for the application ratio between the static style data and the dynamic style data. Hardware may be used instead of the GUI part. The application ratio setting unit 15 is an example of a setting unit that sets the application ratio between the static style data and the dynamic style data.

The style conversion unit 16 receives the static style data, the dynamic style data, and the video acquired by the video acquisition unit 11, and executes style conversion according to the application ratio set by the application ratio setting unit 15. The style conversion unit 16 can employ an algorithm described in NPL 1 above as a style conversion algorithm. For example, the style conversion unit 16 can execute style conversion by transferring a style expression of the style data to each frame (content image) of the video using an image expression obtained from a convolutional neural network (CNN) optimized for object recognition. When character information or the like is used for input instead of an image, characters may be converted into an image in advance, or the character information may be converted into a vector representation in any form. As a result of such style conversion, the style conversion unit 16 can obtain a video after style conversion (second video) having a style expression of the style data while maintaining a content expression of an original video (a first video). The style conversion unit 16 is an example of a conversion unit that executes style conversion using dynamic style data for the first video to generate a second video subjected to the style conversion. The style conversion unit 16 can execute style conversion using the static style data and the dynamic style data at the set application ratio, as described above.

The synchronization processing unit 17 synchronizes a video frame acquired by video acquisition unit 11 with the video frame after style conversion generated by the style conversion unit 16. It is necessary to apply a smooth conversion through switching processing from the original video for style conversion to a video after style conversion (for example, a video to which style conversion in which only costumes are expressed in flames, and the brightness of the flames changes bright depending on a volume of cheering of the audience at the venue or the number of audience members waving a pen-shaped light is applied). In this case, it is necessary for moving images before and after application of the style conversion to be completely linked. For this reason, for example, a time stamp or an identification number is attached to each frame of the video before style conversion, the video acquired by the video acquisition unit 11 being split and passed through a standby circuit (not illustrated) so that a video before style conversion processing is synchronized with the video after processing. The synchronization processing unit 17 is a mechanism capable of synchronizing the video frame after style conversion with the original video frame acquired by the video acquisition unit 11. The synchronization processing unit 17 is an example of a synchronization processing unit that time-synchronizes a frame of the first video with a frame of the second video.

The output unit 18 outputs the original video and a video after style conversion synchronized by the synchronization processing unit 17. As an example, a case in which an image obtained by performing style conversion on only an image captured by the camera C2 over a long period of time is output is assumed as a case in which a scene being performed on the stage is captured by a plurality of cameras (here, C1 and C2) and a screen with a cut (viewpoint) changed by switching between the cameras is distributed as a program. In this case, an output video of C1 and an output video of C2 are synchronized by the synchronization processing unit 17 and thus, when a remote viewer sees the video in the output unit 18, only a video from one viewpoint can be made to appear as if a special effect (style conversion in this case) had been applied even though the same subject is displayed at the same time from different angles, which increases an effect of the performance. The same effect can be expected even when the video of the output unit 18 is displayed on a large screen called a service screen on the stage instead of a television or streaming distribution. The output unit 18 may output only a video (second video) whose style has been converted by the style conversion unit 16. The video to be output can be designated by the user interface 21. The output unit 18 is an example of an output unit that outputs the second video.

The video processing apparatus 1 according to the embodiment of the present invention executes the style conversion adopting the reactions of the viewers of the event in real time with the configuration described above. Accordingly, the video processing apparatus 1 can generate the event video at a higher entertainment level.

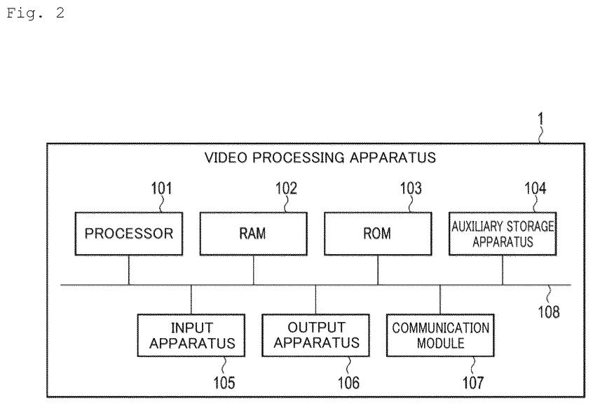

FIG. 2 is a diagram illustrating a hardware configuration example of the video processing apparatus 1. The video processing apparatus 1 can be configured as a computer. The video processing apparatus 1 does not need to be a single computer, and may be configured of a plurality of computers. As illustrated in FIG. 2, the video processing apparatus 1 includes a processor 101, a random access memory (RAM) 102, a read only memory (ROM) 103, an auxiliary storage apparatus 104, an input apparatus 105, an output apparatus 106, and a communication module 107, which are connected via a bus 108.

The processor 101 is a processing circuit capable of executing various programs, and controls an overall operation of the video processing apparatus 1. The processor 101 may be a processor such as a central processing unit (CPU), a micro processing unit (MPU), a graphics processing unit (GPU). Further, the processor 101 may be an application specific integrated circuit (ASIC), a field programmable gate array (FPGA), or the like. Furthermore, the processor 101 may be configured of a single CPU or the like, or may be configured of a plurality of CPUs or the like.

The RAM 102 is a volatile semiconductor memory and is used as a work area for the processor 101. The ROM 103 is a nonvolatile semiconductor memory, and holds a program for controlling the video processing apparatus 1, control data, and the like. The processor 101 loads the program stored in the ROM 103 to the RAM 102, and interprets and executes the program to realize various functions including functions of the video acquisition unit 11, the style acquisition unit 12, the reaction acquisition unit 13, the dynamic style data generation unit 14, the application ratio setting unit 15, the style conversion unit 16, the synchronization processing unit 17, the output unit 18, and the user interface 21.

The auxiliary storage apparatus 104 is a nonvolatile storage apparatus such as a hard disk drive (HDD) or solid state drive (SSD). The auxiliary storage apparatus 104 includes the static style data storage unit 19. Part of the program may be stored in the auxiliary storage apparatus 104.

The input apparatus 105 is an apparatus for receiving an input from the user of the video processing apparatus 1. The input apparatus 105 includes, for example, a touch panel, keyboard, mouse, operation buttons, or operation switches. The input apparatus 105 receives, for example, an input of the application ratio between the static style data and the dynamic style data from the user, and passes the input to the application ratio setting unit 15.

The output apparatus 106 is an apparatus for outputting information. The output apparatus 106 includes, for example, a display or speaker. The display can be, for example, a liquid crystal display apparatus or an organic electro-luminescence (EL) display.

The communication module 107 is a module including a circuit that is used for communication between the video processing apparatus 1 and another device. The communication module 107 may be, for example, a communication module conforming to a wired LAN standard. Further, the communication module 107 may be, for example, a communication module conforming to a wireless LAN standard. The communication module 107 may include a terminal such as a micro universal serial bus (USB) connector. The communication module 107 can communicate with a camera (not illustrated) to receive the first video from the camera.

Regarding a specific hardware configuration of the video processing apparatus 1, it is possible to appropriately omit, replace, and add components according to the embodiment.

An application scene of the style conversion described about the embodiment is not limited to a use scene of conversion of a pre-prepared material or an on-stage video into any preset style and playback of this, like style conversion realized in previous research or commercial cases. The application scene assumed by the video processing apparatus 1 according to the embodiment is intended to extract physical features from some reactions (clapping, cheering, light waving, and the like) that are performed during watching by a large number of audience members watching in front of the stage or viewers watching in a remote environment such as a home, and adopt these as style data. Further, the video processing apparatus 1 enables an application distribution between the static style data prepared in advance and the dynamic style data generated from the physical feature to be dynamically changed.

### (Operation)

Next, an information processing operation of the video processing apparatus 1 configured as described above will be described.

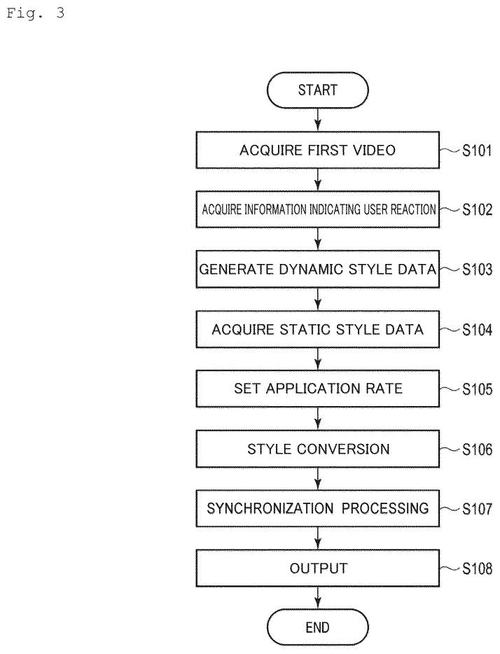

FIG. 3 is a flowchart illustrating an operation example of the video processing apparatus 1. For example, it is assumed that an event such as a live music performance is being held on a stage, and a first camera is installed in audience seats, and the first camera captures videos of performers on the stage from the audience seats during an event. Further, for example, it is assumed that a second camera is installed on the stage, and the second camera captures videos of the audience members in the audience seats from the stage during the event.

In step S101, the processor 101 of the video processing apparatus 1 uses the video acquisition unit 11 to acquire the first video that is the target of the style conversion. The video acquisition unit 11 acquires, for example, a video of the live music from the first camera. The first video that is a target of the style conversion is not limited to a video obtained from a single camera, and may include videos from a plurality of cameras installed at different positions.

In step S102, the processor 101 of the video processing apparatus 1 acquires the information indicating the reaction of the viewer using the reaction acquisition unit 13. The reaction acquisition unit 13 acquires, for example, a video obtained by filming the audience (viewers) during the event from the second camera. This video includes, for example, information such as a motion of the hand of the viewer, a luminance value of the chemical light waved by the viewer, a luminance value of a specific color among light color of the chemical light waved by the viewer, an amount of motion vectors to be extracted from a single viewer or a plurality of viewers, the brightness of audience seats, the number of areas with a luminance value equal to or greater than a certain value, that is, the number of “bright spots”, or sound pressure obtained as audio information. The video acquired by the reaction acquisition unit 13 is not limited to the video acquired from the single camera, and may include videos from a plurality of cameras installed at different positions. The video acquired by the reaction acquisition unit 13 may include a video obtained by filming a viewer watching the event video at a remote place, a captured image of the streaming distribution site or bulletin board site, or the like. The reaction acquisition unit 13 can also acquire, for example, information of the character written on the streaming distribution site or bulletin board site as the information indicating the reaction of the viewer, in addition to the video from the camera or instead of the video from the camera.

In step S103, the processor 101 of the video processing apparatus 1 processes the information indicating the reaction of the viewer to generate dynamic style data using the dynamic style data generation unit 14. In an embodiment, the dynamic style data generation unit 14 is configured to extract a plurality of physical quantities designated via the user interface 21 for each frame, and dynamically select physical quantities to be adopted for the dynamic style data on the basis of change in values thereof. Specifically, the dynamic style data generation unit 14 monitors change in the values of a plurality of physical quantities for each frame, and successively adopts physical quantities indicating change exceeding a preset threshold value as a dynamic style. This makes it possible for the dynamic style data generation unit 14 to generate dynamic style data by instantly reflecting various reaction of viewers such as an increase in cheering of the viewer in a certain scene, the viewer waving the chemical light in another scene, and an increase in writing to a website in another scene. Generally, it is difficult to predict in advance whether the audience will wave chemical light, shout cheers, or clap at the next moment in a quiet stage. Therefore, in an embodiment, the video processing apparatus 1 monitors changes in a plurality of physical quantities using the dynamic style data generation unit 14, and sequentially adopt the physical quantities as a dynamic style, for example, when an amount of change between frames exceeds a predetermined threshold value. Alternatively, the dynamic style data generation unit 14 may extract physical quantities designated via the user interface 21 for each frame and use the extracted physical quantities as the dynamic style data. For example, the dynamic style data generation unit 14 extracts the luminance value of the light color of the chemical light waved by the viewer for each frame from the video obtained by the reaction acquisition unit 13, and uses the luminance value as the dynamic style data.

In step S104, the processor 101 of the video processing apparatus 1 acquires the static style data using the style acquisition unit 12. The style acquisition unit 12 reads corresponding data from the static style data storage unit 19 according to a user instruction input via the user interface 21, for example. The static style data includes pre-prepared texture images.

In step S105, the processor 101 of the video processing apparatus 1 sets the application ratio between the static style data and the dynamic style data using the application ratio setting unit 15. The application ratio setting unit 15 performs a setting according to an instruction of the user input via the user interface 21, for example.

In step S106, the processor 101 of the video processing apparatus 1 receives each frame of the first video acquired in step S101, the dynamic style data acquired in step S103, and the static style data acquired in step S104 using the style conversion unit 16, and executes style conversion according to the application ratio set by the application ratio setting unit 15. The style conversion unit 16 executes encoding processing for a style application target image (style conversion target) and a style image using a CNN capable of extracting features of the image. The style conversion unit 16, for example, obtains the content representation of the first video as a feature map, which is an output of a specific intermediate layer of the CNN. Further, the style conversion unit 16 obtains, for example, a style expression of each of the static style data and the dynamic style data as a gram matrix of a content expression of the same intermediate layer of the CNN. Here, the style conversion unit 16 performs processing for extracting and pooling generated data of a plurality of intermediate layers, and alternating (so-called “style swap”) features extracted from a specific layer during encoding between the style application target image and the style image. Accordingly, in a decoding phase, an image reflecting the features of the style image is restored in the style application target image. According to this method, there is no need for pre-learning using a large amount of data in order to extract an image feature of the style application target image and the style image, and it is possible to achieve fast processing.

The designation of a layer whose feature is to be swapped and a unit of processing in the CNN (a window size of an image area of each of the style application target image and the style image) may be determined heuristically while the user visually confirming a state of the style conversion and determined via the user interface 21. Alternatively, an intermediate amount that minimizes a linear sum of a content loss and a style loss may be swapped by gradient descent or the like.

An application ratio and granularity of the style conversion may be applied in any method. As an example, when an image is used as a style, a subset of regions can be set to the granularity of 1. For example, when a video in which an audience waves chemical light is adopted as the style image, the number of bright spots extracted from the video is used as the style data.

In step S107, the processor 101 of the video processing apparatus 1 executes synchronization processing using the synchronization processing unit 17. Since style conversion takes time (for example, about several tens of seconds), the synchronization processing unit 17 time-synchronize a frame of the original video (the first video) with a frame of the video after style conversion (the second video) and passes the video to the output unit 18.

In step S108, the processor 101 of the video processing apparatus 1 outputs the first video and the second video synchronized by the synchronization processing unit 17 as video data using the output unit 18. As an example, the video processing apparatus 1 transmits the video data to a terminal of the viewer at a remote place via the communication module 107 using the output unit 18. Examples of the terminal of the viewer include a smart phone, a mobile phone terminal, a personal computer, a tablet terminal, a game machine, a television receiver, and a wearable terminal such as a head-mounted display. The viewer can display the video based on the received video data on a display of the terminal and view the event video to which the style conversion has been applied. The event video displayed on the terminal of the viewer is obtained, for example, by performing the style conversion on a live video obtained by filming the live music on the stage using color information of the chemical light of the audience in front of the stage as the dynamic style data. Accordingly, the viewer can enjoy live music while feeling senses of unity and realism with other audience members while being at a remote place. Further, a behavior of the viewer at the time of viewing is dynamically reflected in the style. A display mode on the terminal of the viewer may be able to arbitrarily switch among a display of the original video (first video) only, a display of the video after style conversion (second video) only, and simultaneous display (for example, side by side vertically or horizontally or superimposition on each other) of the original video and the video after style conversion.

The flow illustrated in FIG. 3 is merely an example, and an order of processing may be replaced appropriately. For example, the static style data acquisition processing of step S104 may be executed before steps S101 to S103, or may be executed in parallel with steps S101 to S103. Similarly, application ratio setting processing in step S105 may be executed at any timing.

### (Effects)

As described in detail above, in the video processing apparatus 1 according to the embodiment of the present invention, the video acquisition unit 11 acquires the first video related to the event, the reaction acquisition unit 13 acquires the information indicating the reaction of the viewer who watches the event, the dynamic style data generation unit 14 generates dynamic style data on the basis of the information indicating the reaction of the viewer, and the style conversion unit 16 executes the style conversion using the dynamic style data for the first video to generate the second video subjected to style conversion, and the output unit 18 outputs the second video. The second video to be output is obtained by real-time transfer of the style of the dynamic style data generated on the basis of the information indicating the reaction of the viewer to the first video. The viewer at a remote place can view the second video to perceive reactions of other viewers and enjoy a sense of unity and realism with the other viewers.

The dynamic style data generation unit 14 monitors physical quantities that can be extracted as the information indicating the reaction of the viewer, and generates dynamic style data. This makes it possible for the video processing apparatus 1 to use, for the style conversion, dynamic information not directly related to a texture of an image, such as the appearance, motion, or volume of a vocal sound of the audience, or a frequency of writing on a website. Even in events such as performing arts in which there are many elements difficult to predict in a reaction of the audience, it is possible to execute the style conversion with a higher degree of realism by using such dynamic style data.

In the video processing apparatus 1, the style acquisition unit 12 acquires the static style data, the application ratio setting unit 15 sets the application ratio between the static style data and the dynamic style data, and the style conversion unit 16 applies the static style data and the dynamic style data using the set application ratio to execute the style conversion. Accordingly, the obtained video after style conversion (the event video or the second video) can reflect the reaction of the viewer in real time and can provide video with a certain degree of uniformity due to the static style data.

In the video processing apparatus 1, the synchronization processing unit 17 further time-synchronizes the frame of the first video with the frame of the second video, and the output unit 18 outputs the first video time-synchronized with the second video together with the second video. This makes it possible to obtain a video set of the first video and the second video that is not influenced by a delay of time required for style conversion.

In recent years, attempts have been proposed to enable style conversion in real time. However, there is no known system including a mechanism that adopts the reaction of the viewer as the dynamic style and can freely control an adopting proportion of the reaction, as in the embodiment. It is not easy to realize the style conversion processing according to the embodiment by simply combining published literatures.

With the video processing apparatus 1 according to the embodiment, it is possible to realize not only a fixed style (static style) set in advance but also dynamic style conversion that adopts reactions of all viewers watching the stage.

### Modification Example

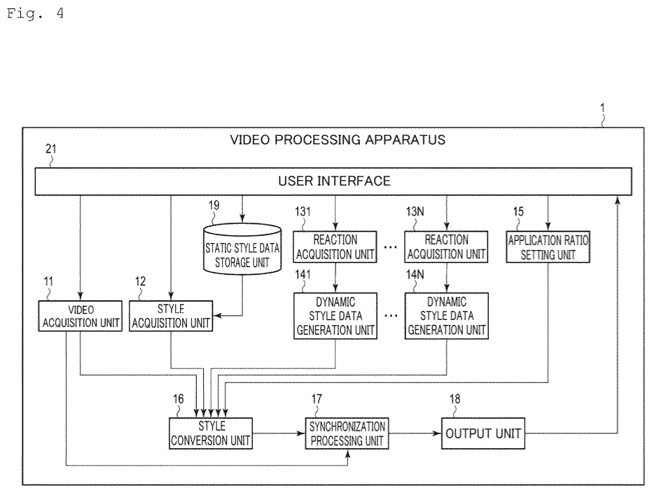

FIG. 4 illustrates a modification example of the functional configuration of the video processing apparatus 1. In this modification example, the video processing apparatus 1 applies reactions of a plurality of viewers to the style conversion. The plurality of viewers includes, for example, viewers at a performance venue, viewers at a remote venue, or viewers watching on a display of a terminal at home.

The video processing apparatus 1 illustrated in FIG. 4 has the same configuration as a video processing apparatus 1 illustrated in FIG. 1, except that a plurality of reaction acquisition units 131, . . . , 13N and a plurality of dynamic style data generation units 141, . . . , 14N are included instead of the reaction acquisition unit 13 and the dynamic style data generation unit 14. Hereinafter, differences from the video processing apparatus 1 illustrated in FIG. 1 will be mainly described.

The reaction acquisition units 131, . . . , 13N each acquire information indicating reactions of one or a plurality of viewers. The reaction acquisition units 131, . . . , 13N may acquire information indicating different types of reactions. For example, a certain reaction acquisition unit 131 may acquire a video in which the viewer waves the chemical light at the performance venue, and another reaction acquisition unit 13x may acquire a vocal sound input to a terminal by a viewer watching at home.

The dynamic style data generation units 141, . . . , 14N receive information indicating the reactions acquired from the reaction acquisition units 131, . . . , 13N to generate corresponding dynamic style data, respectively. The dynamic style data generation units 141, . . . , 14N may generate different types of dynamic style data using different processing.

The video processing apparatus 1 illustrated in FIG. 4 can also adopt the same hardware configuration example as that illustrated in FIG. 2.

This modification example makes it possible to execute style conversion that has reflected reactions of a plurality of viewers at different geographical positions. The video after style conversion is presented to the viewer, so that the viewer can feel a sense of unity with other viewers regardless of whether the viewers are at the performance venue, at the remote venue, or at home. Similarly, the video after style conversion is presented to the performer himself, so that the performer can perceive reactions of not only audience members in front of the performer but also viewers at remote places.

### Other Embodiments

The present invention is not limited to the embodiment. For example, respective functions included in the video processing apparatus 1 may be distributed to and disposed in a plurality of apparatuses, and these apparatuses may cooperate with each other to perform processing. Further, each functional unit may be realized by using a circuit. The circuit may be a dedicated circuit that realizes a specific function, or may be a general-purpose circuit such as a processor.

The dynamic style data to be used for style conversion is not limited to one type of data. For example, the style conversion using a plurality of styles can also be realized by combining dynamic style data that reflects the color of the chemical light with dynamic style data that reflects the magnitude of the vocal sound of the viewer in an arbitrary ratio, and applying the static style data at the application ratio set as described above.

A flow of each processing described above is not limited to the described procedure, and an order of some steps may be changed, and some steps may be performed simultaneously in parallel.

A scheme described above can be stored in, for example, a recording medium (storage medium) such as a magnetic disk (a floppy (registered trademark) disk, a hard disk, or the like), an optical disc (a CD-ROM, a DVD, a MO, or the like), a semiconductor memory (a ROM, a RAM, a flash memory, or the like) as a program (software means) that can be executed by a calculator (computer), and transmitted and distributed by a communication medium. The program stored in the medium side also includes a setting program for configuring, in the calculator, software means (including not only an execution program but also a table and the data structure) to be executed by the calculator. The calculator realizing the apparatus executes the above-described processing by loading the program recorded on the recording medium or constructing a software means using the setting program in some cases, and controlling an operation using the software means. The recording medium referred to herein is not limited to a recording medium for distribution, and includes a storage medium such as a magnetic disk or a semiconductor memory provided inside the calculator or in a device connected via a network.

The present invention is not limited to the above embodiment, and can be modified in various ways without departing from the gist thereof at an implementation stage. Further, respective embodiment may be combined appropriately and implemented and, in this case, combined effects can be achieved. Further, the foregoing embodiment include various inventions, and various inventions can be extracted by combinations selected from the plurality of components disclosed herein. For example, as long as the problem can be solved and the effects can be achieved even when several of the components described in the embodiment are removed, a configuration in which the components have been removed can be extracted as an invention.

### REFERENCE SIGNS LIST

1 Video processing apparatus
11 Video acquisition unit
12 Style acquisition unit
13, 131, 13N Reaction acquisition unit
14, 141, 14N Dynamic style data generation unit
15 Application ratio setting unit
16 Style conversion unit
17 Synchronization processing unit
18 Output unit
19 Static style data storage unit
21 User interface
101 Processor
102 RAM
103 ROM
104 Auxiliary storage apparatus
105 Input apparatus
106 Output apparatus
107 Communication module

1. A video processing apparatus, comprising:
video acquisition circuitry configured to acquire a first video related to an event;
reaction acquisition circuitry configured to acquire information indicating a reaction of a viewer watching the event;
generation circuitry configured to generate dynamic style data on the basis of the information indicating the reaction of the viewer;
conversion circuitry configured to execute style conversion using the dynamic style data for the first video to generate a second video subjected to style conversion; and
output circuitry configured to output the second video.

2. The video processing apparatus according to claim 1, further comprising:
style acquisition circuitry configured to acquire static style data; and
setting circuitry configured to set an application ratio between the static style data and the dynamic style data,
wherein the conversion circuitry applies the static style data and the dynamic style data using the set application ratio to execute the style conversion.

3. The video processing apparatus according to claim 1, further comprising:
synchronization processing circuitry configured to time-synchronize the frame of the first video with the frame of the second video, wherein
the output circuitry outputs the first video time-synchronized with the second video together with the second video.

4. The video processing apparatus according to claim 1, wherein the reaction acquisition circuitry acquires a video obtained by filming the viewer watching the event, writing on an Internet site related to the event, or vocal sound uttered toward a terminal by the viewer, as information indicating the reaction of the viewer.

5. A video processing method, comprising:
acquiring a first video related to an event
acquiring information indicating a reaction of a viewer watching the event;
generating dynamic style data on the basis of the information indicating the reaction of the viewer;
executing style conversion using the dynamic style data for the first video to generate a second video subjected to style conversion; and
outputting the second video.

6. A non-transitory computer readable medium storing program for causing a computer to execute the method of claim 5.
